(19) United States
(12) Patent Application Publication
(10) Pub. No.: US 2003/0208665 A1
(43) Pub. Date: Nov. 6, 2003

(54) Reducing data speculation penalty with early cache hit/miss prediction

(76) Inventors: Jih-Kwon Peir, Gainesville, FL (US); Konrad Lai, Vancouver, WA (US)

Correspondence Address: FISH & RICHARDSON, PC, 4350 LA JOLLA VILLAGE DRIVE, SUITE 500, SAN DIEGO, CA, 92122, US

(21) Appl. No.: 10/138,039

(22) Filed: May 1, 2002

(51) Int. Cl. G06F 12/00

(52) U.S. Cl. 711/169; 711/125; 711/167

(57) ABSTRACT

A processor may use a cache hit/miss prediction table (CPT) to predict whether a load will hit or miss and use this information to schedule dependent instructions in the instruction pipeline. The CPT may be a Bloom filter which uses a portion of the load address to index the table.

### BACKGROUND

In a pipelined processor, it may be necessary to know the latency of a load instruction in order to schedule the load's dependent instructions at the correct time. Memory load latency may present a pipeline bottleneck even when the data is present in the processor's first-level (L1) cache. This may occur because the load data may not be ready until late stages of the pipeline while the dependent instruction may require the data at an earlier stage. Further contributing to this load latency problem is the requirement that the dependent instruction be scheduled for execution before cache hit/miss detection to minimize the effective load latency.

Many existing data speculation methods schedule dependent instructions on the assumption that the load always hits the cache. While this may be true most of the time, in the event a cache miss occurs, the speculative dependent instructions may need to be cancelled. The cancelled dependent instructions may then be replayed through the pipeline with the correct load data. In a deeply pipelined processor, such replays may incur heavy performance penalties.

### BRIEF DESCRIPTION OF THE DRAWINGS

FIG. 1 is a block diagram of a processor including a cache hit/miss prediction table (CPT).

FIG. 2 is a block diagram of a CPT.

FIG. 3 is a flowchart describing a cache hit/miss prediction operation.

FIG. 4A is a block diagram illustrating the condition of instruction in a pipeline when a cache miss is filtered by a CPT.

FIG. 4B is a block diagram illustrating the flow of a load instruction and a dependent add instruction in a pipeline.

FIG. 5 is a block diagram of a Bloom filter.

FIG. 6 is a block diagram of a partial-address Bloom filter CPT.

FIG. 7 is a block diagram of a partitioned-address Bloom filter CPT.

### DETAILED DESCRIPTION

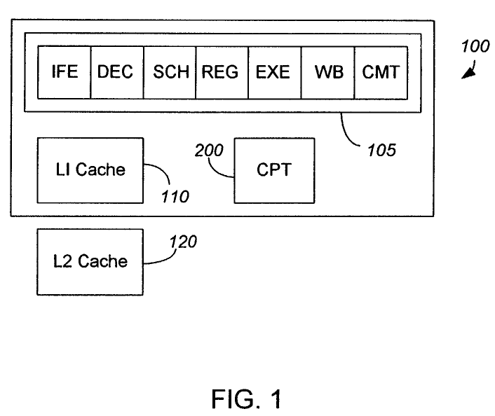

FIG. 1 illustrates a processor 100 according to an embodiment. The processor 100 may have a deeply pipelined, load/store architecture. The processor 100 may execute ALU (Arithmetic Logic Unit) instructions in seven pipeline cycles: instruction fetch (IFE), decode/rename (DEC), schedule (SCH), register read (REG), execute (EXE), writeback (WRB), and commit (CMT). Loads may extend the execute stage to four cycles, including address generation (AGN), two cache access cycles (CA1, CA2), and hit/miss determination (H/M) cycle.

An instruction in the pipeline 105 may depend on the result of a previous, i.e., parent, instruction. To improve throughput, the processor 100 may schedule such a dependent instruction before the parent instruction executes. The processor 100 may speculate that a load will hit the cache 110 and schedule the dependent instructions accordingly. If the load hits the cache, the parent and dependent instructions may execute normally. However, if the load misses the cache, any dependent instructions that have been scheduled will not receive the load's result before they begin execution. All of these instructions may need to be rescheduled and a recovery operation performed. This is referred to as data misspeculation. Although misspeculation is rare, the overall penalty for all misspeculations may be high, as the cost of each recovery may be high.

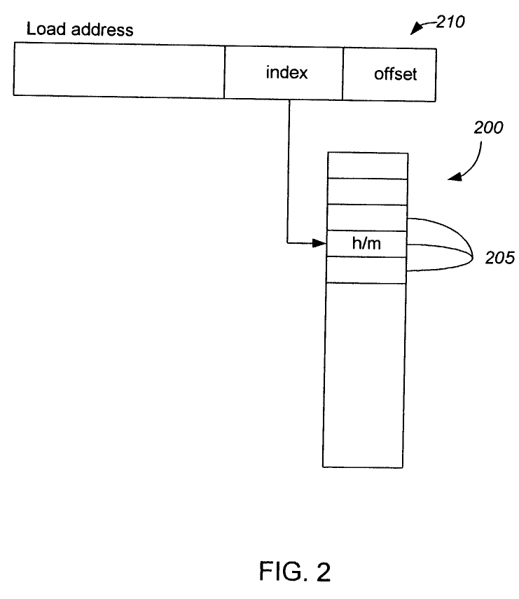

The processor 100 may establish a cache hit/miss prediction table (CPT) to record the hit/miss history of memory references and use the CPT to predict cache hit/miss for future memory references. FIG. 2 illustrates the design of a CPT 200. The CPT 200 may be a hashed table. Entries 205 in the CPT may be indexed by a hash value generated from portion(s) of a load address 210. Depending on the CPT size, certain index bits 215 located beyond the line offset 220 portion of the local address may be extracted from the load address 210 and used to produce a hash value used to access the CPT for making the cache hit/miss prediction.

Each entry 205 in the CPT 200 may have a single bit to indicate either a hit or a miss. When a cache miss occurs for both loads and stores, the CPT may be updated. The entry associated with the newly requested line from the cache may be set to hit (e.g., “1”), while the entry associated with the replaced line is reset to miss (e.g., “0”). In case the new and the replaced lines are hashed to the same entry, i.e., have the same hash value, the entry may be set to hit only.

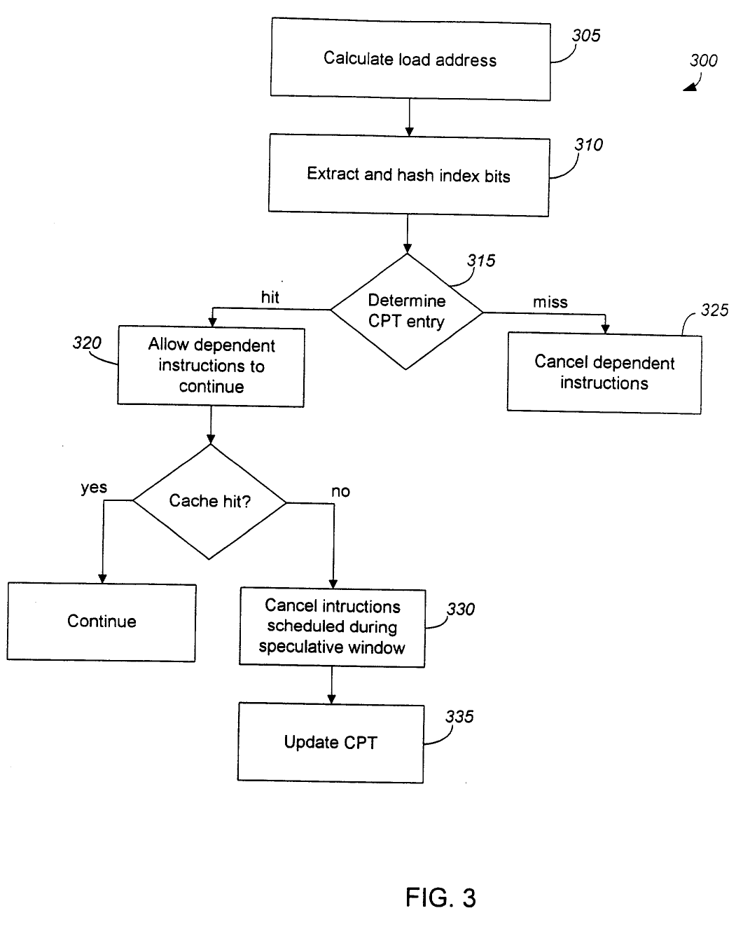

FIG. 3 illustrates a flowchart describing an instruction scheduling operation 300 using the CPT 200. Dependent instructions waiting on the load may be scheduled at the cycle after the address generation to avoid any pipeline bubbles. The dependent instructions of a load may be scheduled aggressively assuming a cache hit.

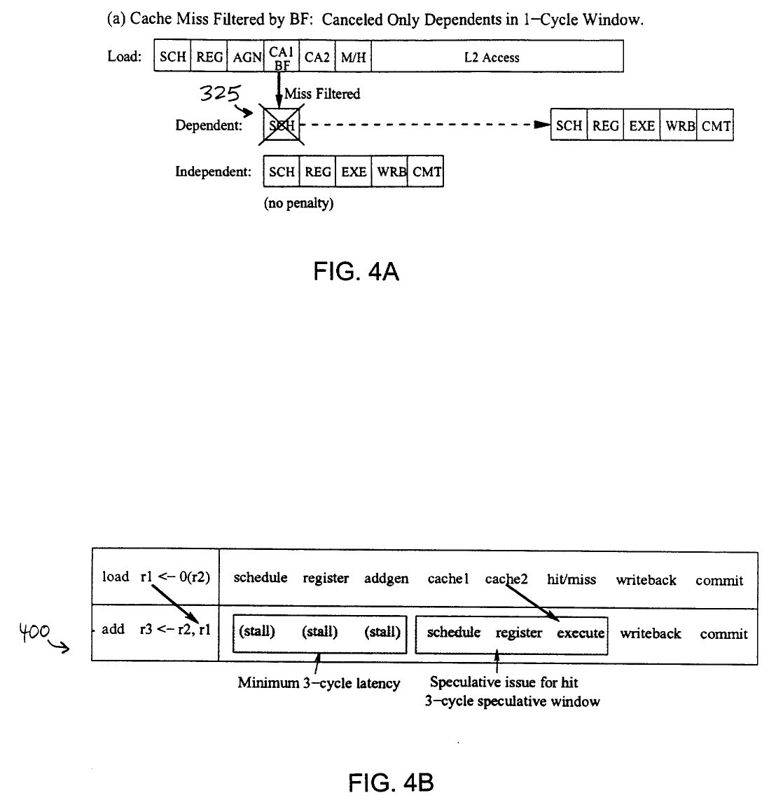

The cache hit/miss prediction may be performed after the load address is calculated in the address generation cycle, e.g., at the end of the cycle when the dependent instructions are scheduled (block 305). The index bits in the load address may be extracted and hashed (block 310). The corresponding entry in the CPT may then be determined (block 315). If the entry indicates a hit, the dependent instructions may be allowed to continue in the pipeline (block 320). If the entry indicates a miss, the dependent instructions may be canceled and recovered in the next cycle (block 325), as shown in FIG. 4A. Independent instructions scheduled during this one cycle window may be allowed to continue regardless. Once a miss is identified, the miss request may be issued to the second level (L2) cache 120.

Using a small, direct mapped, no tag CPT, cache misses may be filtered in one cycle after the address generation, which is two cycles before the hit/miss determination, as shown in FIG. 4B, which illustrates a dependent add instruction flow 400. Since there is only a single cycle speculative window, a precise recovery of the load dependent instructions may be feasible without excessive hardware complexity. This may be achieved through blocking the scheduled load dependent instructions from broadcasting their tags to their dependent instructions and not waking these latter instructions.

When a cache hit is incorrectly predicted by the CPT 200, and a cache miss is detected during the regular cache access, all of the instructions that are scheduled during the speculative window may be canceled (block 330). The CPT may also be updated in response to such an unpredicted cache miss (block 335). The entry associated with the newly requested line in the cache which is received in response to the cache miss may be set to “hit” in the CPT, while the entry associated with the line the newly requested lines replaces in the cache may be set to “miss” in the CPT. In the event the new and the replaced lines are hashed to the same entry, the entry is set to hit only.

The size of the CPT 200 may be flexible. Multiple cache lines with same index bits may share the same entry in the CPT. Therefore, a CPT including a number of entries that are several times larger than the number of cache lines may minimize such conflicts and provide high accuracy in hit/miss prediction.

The CPT may be a Bloom filter. A Bloom filter is a probabilistic algorithm to quickly test membership in a large set using multiple hash functions into an array of bits. A Bloom filter quickly filters (i.e., identifies), non-members without querying the large set by exploiting the fact that a small percentage of erroneous classifications can be tolerated. When a Bloom filter identifies a non-member, it is guaranteed to not belong to the large set. When a Bloom filter identifies a member, however, it is not guaranteed to belong to the large set. In other words, the result of the membership test is either: it is definitely not a member, or, it is probably a member.

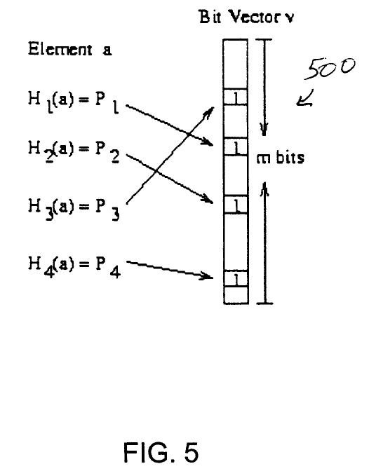

A Bloom filter 500 may be represented as a set A={a₁, a₂, . . . , aₙ} of n elements (also called keys), as shown in FIG. 5.

The idea (illustrated in FIG. 5) is to allocate a vector v of m bits, initially all set to 0, and then choose k independent hash functions, h1, h2, . . . , hk, each with range {1, . . . , m}. For each element aεA, the bits at positions h₁(a), h₂(a), . . . , hₖ(a) in v are set to “1”. A particular bit might be set to 1, multiple times.

Given a query for b, the bits at positions h₁(b), h₂(b), . . . , hₖ(b) are checked. If any of the bits is “0”, then b is not in the set A. Otherwise, it may be assumed that b is in the set although there is a certain probability that this is not true. This is called a “false positive,” or “false drop.” There is a tradeoff between m and the probability of a false positive. The parameters k and m should be chosen such that the probability of a false positive (and hence a false hit) is acceptable.

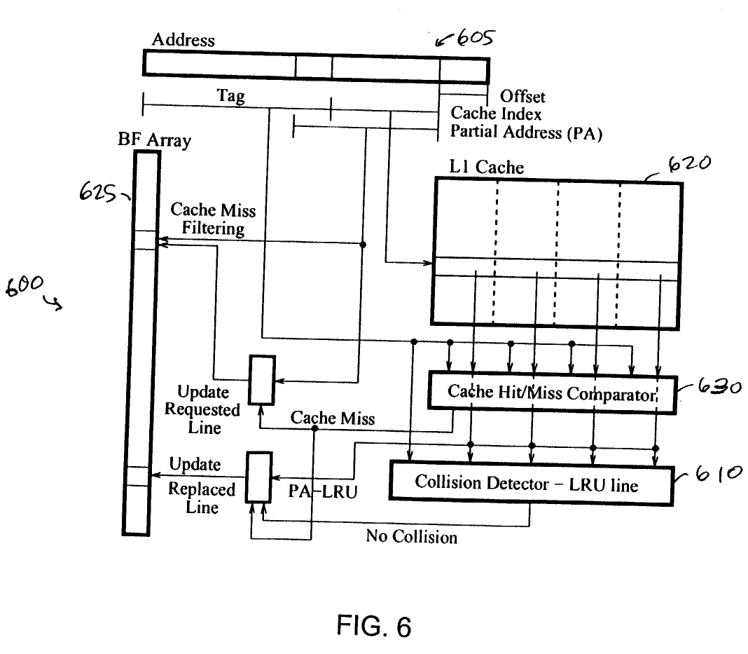

FIG. 6 illustrates a partial-address Bloom filter CPT 600 which uses the least-significant bits of the line address 605 to index a small array of bits. Each bit indicates whether the partial address matches any corresponding partial address of a line in the cache. The array size is reduced to 2ⁿ bits, where p is the number of partial address bits. A filter error occurs when the partial address of the requested line matches the partial address of an existing cache line, but the other portion of the line address does not match. This is referred to as a collision, which are detected by a collision detector 610. The least-significant bits may be selected rather than more-significant bits to reduce the chance of collisions. Due to memory reference locality, the more-significant line address bits tend to change less frequently.

A Bloom filter array 625 with 2ⁿ bits indicates whether the corresponding partial address matches that of any cache line 615 in the L1 cache 620. The Bloom filter array 625 may be updated to reflect any cache content change. When a cache miss occurs, except for the caveat described in the paragraph below, the entry in the Bloom filter array for the replaced line may be reset to indicate that the line with that partial address is no longer in the cache. Then, the entry for the requested line may be set to indicate that a line with that partial address now exists in the cache 620.

When two cache lines share the same partial address, if the partial address is wider than the cache index, they must be in the same set in a set-associative cache. If one of these lines is replaced, the entry for the replaced line should not be reset. The collision detector 610 checks for matching partial addresses and determines whether to reset the entry for the replaced line. When a cache line is replaced, the other lines in the same set must be checked to see if they have the same partial address as the replaced line. The entry is reset only if there is no match. These collision detections may be performed in parallel with the cache hit/miss detection by a cache hit/miss comparator 630. The updates of the Bloom filter array 625 may occur upon the detection of a miss.

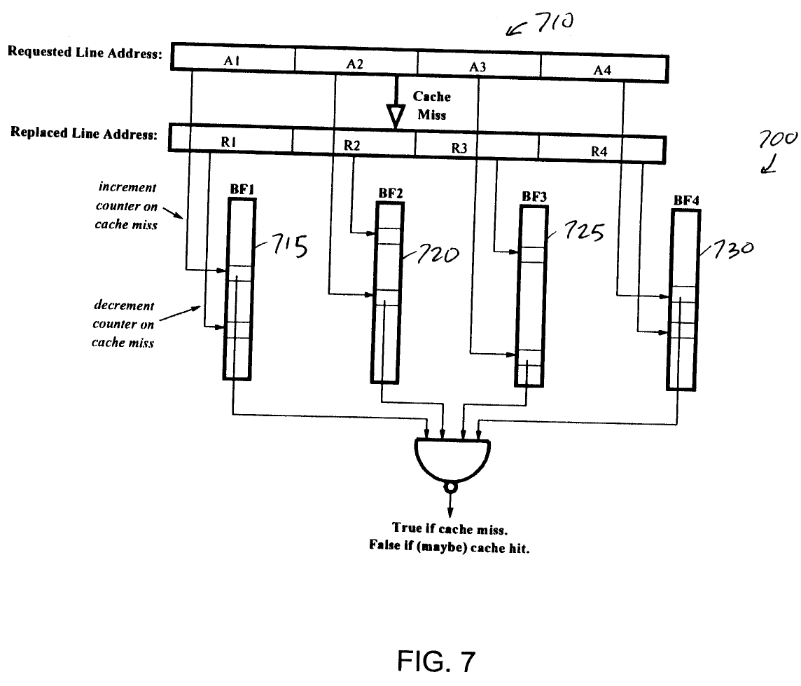

FIG. 7 illustrates a partitioned-address Bloom filter CPT 700. The load address may be split into m partitions, with each partition using its own array of bits. The result is m sub-arrays with 2^{n/m} bits, each of which records the membership of the respective address partitions stored in the cache. A cache miss is filtered when one or more of the address partitions for the address of a requested line 710 does not belong to the respective address partition of any line in the cache. A filter error is encountered when the line is not in the cache, but all m partitions of the line's address match address partitions of other cache lines. The filter rate represents the percentage of cache misses that may be filtered. In the example shown in FIG. 7, the load address is partitioned into four equally divided groups, A1, A2, A3, and A4. Each of the four address partitions is used to index separate Bloom filter arrays, BF1 715, BF2 720, BF3 725, and BF4 730, respectively. Each entry in the Bloom filter arrays contains the information of whether the address partition belongs to the corresponding address partition of any line in the cache. If any of the four Bloom filter arrays indicates one of the address partitions is absent from the cache, the requested line is not in the cache. Otherwise, the requested line is probably in the cache, but is not guaranteed to be.

Given the fact that a single address partition may exist for multiple lines in the cache, it is important to maintain the correct membership information. When a line is removed from the cache, a search may be performed to check if the address partitions for the address of the removed line still exist for any of the remaining lines. To avoid such a search, each entry in the Bloom filter array may contain a counter that keeps track of the number of cache lines with the entry's corresponding address partition. When a cache miss occurs, each counter for the address partitions for the address of the newly-requested line is incremented, while the counters for the address partitions for the address of the replaced line are decremented. A zero count indicates the corresponding address partition does not belong to any line in the cache.

A number of embodiments have been described. Nevertheless, it will be understood that various modifications may be made without departing from the spirit and scope of the invention. For example, blocks in the flowchart may be skipped or performed out of order and still yield desirable results. Accordingly, other embodiments are within the scope of the following claims.

1. A method comprising:
scheduling a dependent instruction having an associated memory address;
identifying an entry corresponding to the memory address in a table;
reading a cache hit/miss prediction value associated with said entry; and
canceling the dependent instruction in response to said cache hit/miss prediction value indicating a cache miss.

2. The method of claim 1, further comprising allowing the dependent instruction to proceed in a pipeline in response to the cache hit/miss prediction value indicating a cache hit.

3. The method of claim 1, further comprising:
accessing a cache with said memory address; and
updating the cache hit/miss prediction value for the entry in the table associated with the memory address in response to the cache hit/miss prediction value being false.

4. The method of claim 1, wherein said identifying comprises generating a hash value from at least a portion of said memory address.

5. The method of claim 1, further comprising rescheduling a dependent instruction after a cache access operation for said memory address.

6. Apparatus comprising:
a table including a plurality of entries, each entry having an associated cache hit/miss prediction value indicating one of a cache hit and a cache miss;
a filter operative to generate a value from at least a portion of a memory address and to identify one of said plurality of entries corresponding to said value; and
a comparator operative to detect whether a cache access for said memory address misses and to update the cache hit/miss prediction value corresponding to that memory address in response to the cache hit/miss prediction value being false.

7. The apparatus of claim 6, wherein the value comprises a hashed value.

8. The apparatus of claim 6, wherein the filter comprises a Bloom filter.

9. The apparatus of claim 6, further comprising a detector operative to detect whether a plurality of memory addresses correspond to the same entry in the table.

10. Apparatus comprising:
a pipeline;
a cache hit/miss prediction table including a plurality of entries, each entry having an associated cache hit/miss prediction value indicating one of a cache miss and a cache hit;
a filter operative to generate a value from at least a portion of a memory address and to identify one of said plurality of entries corresponding to said value; and
a scheduler operative to cancel a dependent instruction, associated with said memory address, in the pipeline and to reschedule said dependent instruction in response to the cache hit/miss prediction value associated with said memory address indicating a cache miss.

11. The apparatus of claim 10, further comprising a cache, and wherein the scheduler is operative to reschedule said dependent instruction after a cache access operation in response to the cache hit/miss prediction value associated with said memory address indicating a cache miss.

12. The apparatus of claim 10, further comprising a comparator operative to detect whether a cache access for said memory address misses and to update the cache hit/miss prediction value corresponding to that memory address in response to the cache hit/miss prediction value being false.

13. The apparatus of claim 10, wherein the value comprises a hashed value.

14. The apparatus of claim 10, wherein the filter comprises a Bloom filter.

15. The apparatus of claim 10, further comprising a detector operative to detect whether a plurality of memory addresses correspond to the same entry in the table.

16. An article comprising a machine-readable medium including machine-executable instructions, the instructions operative to cause a machine to:
schedule a dependent instruction having an associated memory address;
identify an entry corresponding to the memory address in a table;
read a cache hit/miss prediction value associated with said entry; and
cancel the dependent instruction in response to said cache hit/miss prediction value indicating a cache miss.

17. The article of claim 16, further comprising instructions operative to cause the machine to allow the dependent instruction to proceed in a pipeline in response to the cache hit/miss prediction value indicating a cache hit.

18. The article of claim 16, further comprising instructions operative to cause the machine to:
access a cache with said memory address; and
update the cache hit/miss prediction value for the entry in the table associated with the memory address in response to the cache hit/miss prediction value being false.

19. The article of claim 16, wherein the instructions operative to cause the machine to identify comprise instructions operative to cause the machine to generate a hash value from at least a portion of said memory address.

20. The article of claim 16, further comprising instructions operative to cause the machine to reschedule a dependent instruction after a cache access operation for said memory address.
